(19) United States
(12) Patent Application Publication
(10) Pub. No.: US 2009/0011738 A1
(43) Pub. Date: Jan. 8, 2009

(54) Mobile communication apparatus

(76) Inventor: Akihiro Sasakura, Kawasaki (JP)

Correspondence Address: HANIFY & KING PROFESSIONAL CORPORATION, 1875 K STREET, NW, SUITE 707, WASHINGTON, DC, 20006, US

(21) Appl. No.: 12/232,060

(22) Filed: Sep. 10, 2008

Related U.S. Application Data
(63) Continuation of application No. PCT/JP2006/315331, filed on Aug. 2, 2006.

(30) Foreign Application Priority Data
Mar. 10, 2006 (JP) PCT/JP2006/304776

(51) Int. Cl. H04M 1/66

(52) U.S. Cl. 455/410

(57) ABSTRACT

In order to provide a mobile communication apparatus that is capable of preventing a fraudulent access, via the mobile communication apparatus, to a data communication service intended for a mobile communication apparatus; a mobile communication apparatus 10 comprises, at least, communication connection unit 12a and 12b for connecting to a mobile communication network 11 and the like; communication unit 13 for performing data communication with the mobile communication network and the like via the communication connection unit 12; and communication control unit 14 for controlling the communication connection unit 11.

### CROSS REFERENCE TO RELATED APPLICATION

This application is a continuation of PCT application of PCT/JP2006/315331, which was filed on Aug. 2, 2006.

### BACKGROUND OF THE INVENTION

1. Field of the Invention

The present invention relates to a mobile communication apparatus that can be connected to a network such as the Internet to perform data communication.

2. Description of the Related Art

Recently, environment for the Internet use has been enhanced, while mobile apparatuses such as PDA (Personal Digital Assistance) have become popular. Many of mobile apparatuses are also available for use as a mobile communication apparatus that can be connected to a mobile communication network.

Users of a mobile communication apparatus generally use a mobile communication apparatus to connect to an ISP (Internet Services Provider), through which the users connects to the Internet.

An increasing number of ISPs are providing data communication services for mobile communication apparatuses with inexpensive charging systems, because the Internet communication using a mobile communication apparatus statistically involves less communication volume than the Internet communication using an information processing apparatus such as a PC (Personal Computer), and also because there is a need for differentiation from the Internet communication using a PC and so on.

When providing a data communication service for a mobile communication apparatus, a judgment needs to be performed to determine whether or not the apparatus for receiving the data communication service is a mobile communication apparatus (such as a PDA).

Patent Document 1 discloses an apparatus authentication system that is capable of recognizing, using a data communications device, the model used by a user of services such as data distribution service, to provide an appropriate service depending on the model.

However, while the above unit is capable of recognizing the apparatus for using the data communication service, it also enables, for example, a fraudulent use of the inexpensive data communication service intended for mobile communication apparatuses, by a malicious user using a PC, by installing a special application in a mobile communication apparatus to make it function as a router, and connecting, to the PC, an external interface provided in the mobile communication apparatus, such as a USB interface or wireless LAN interface.

Patent Document 2 disclose a method for preventing fraudulent use of a network that could happen when Bluetooth is used for the communication between the network and a mobile device.
Patent Document 1: Japanese Patent Application Publication No. 2004-355562
Patent Document 2: Japanese Patent Application Publication No. 2002-320274

### SUMMARY OF THE INVENTION

The present invention has been made in view of the above issues. A problem to be solved by the present invention is to provide a mobile communication apparatus that is capable of preventing a fraudulent access, via the mobile communication apparatus, to a data communication service intended for a mobile communication apparatus.

In order to solve the above problem, a mobile communication apparatus according to the present invention can be connected to a mobile communication network, and comprises communication connection unit for enabling data transmission/reception by connecting, electromagnetically or electrically, the mobile communication apparatus and the mobile communication network, another information processing apparatus or a network; and communication unit for performing data communication by connecting to the mobile communication network using the communication connection unit; and communication control unit for disabling, during the data communication, communication of data that uses any communication connection unit except for the communication connection unit that is being used for the data communication.

According to the present invention, when the communication unit starts data communication using the communication connection unit, the communication control unit disables all communication connection unit except for the one that is being used for the data communication. Therefore, the present invention has an effect of preventing a fraudulent access to a data communication service intended for a mobile communication apparatus, the access being made, via a mobile communication apparatus, from an information processing apparatus and the like connected to the mobile communication apparatus.

As described above, the present invention makes it possible to provide a mobile communication apparatus that is capable of preventing a fraudulent access, via the mobile communication apparatus, to a data communication service intended for a mobile communication apparatus.

### BRIEF DESCRIPTION OF THE DRAWINGS

FIG. 1 is a diagram describing the principle of the present invention.

FIG. 2 is a diagram illustrating an example of a hardware configuration of a mobile communication apparatus according to an embodiment of the present invention.

FIG. 3 is a schematic diagram showing functions of a mobile communication apparatus according to a first embodiment of the present invention.

FIG. 4 is a flowchart showing processes performed by the mobile communication apparatus according to the first embodiment of the present invention.

FIG. 5 is a flowchart showing a communication monitoring process performed by the mobile communication apparatus according to the first embodiment of the present invention.

FIG. 6 is a schematic diagram showing functions of a mobile communication apparatus according to a second embodiment of the present invention.

FIG. 7 is a flowchart showing processes performed by the mobile communication apparatus according to the second embodiment of the present invention.

FIG. 8 is a flowchart showing a communication monitoring processes performed by the mobile communication apparatus according to the second embodiment of the present invention.

FIG. 9 is a schematic diagram showing functions of a mobile communication apparatus according to a third embodiment of the present invention.

FIG. 10 is a flowchart showing processes performed by the mobile communication apparatus according to the third embodiment of the present invention.

### DESCRIPTION OF THE PREFERRED EMBODIMENTS

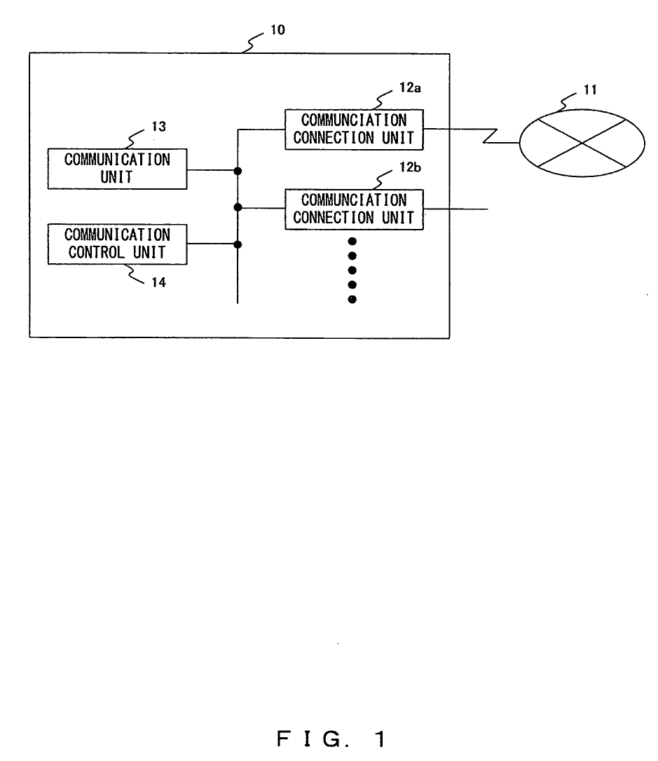

Embodiments of the present invention are described below, in reference to FIG. 1-FIG. 10.

FIG. 1 is a diagram describing the principle of the present invention.

A mobile communication apparatus 10 comprises, at least, communication connection unit 12a and 12b for connecting to a mobile communication network 11 and the like; communication unit 13 for performing data communication with the mobile communication network 11 and the like via the communication connection unit 12a or 12b; and communication control unit 14 for controlling the communication connection unit 12.

The mobile communication network 11 is, for example, a mobile-phone communication network or a PHS communication network with which telephone-service providers provide services such as voice communication and data communication, or a communication network with which ISPs and the like provide wireless communication services.

The communication connection unit 12a and 12b are unit to electrically (electromagnetically) connect the mobile communication apparatus 10 to the mobile communication network 11, an information processing apparatus or a network (not shown in the drawings) to perform data reception/transmission. Examples include a communication module, USB (Universal Serial Bus), SD (Secure Digital) IO, Bluetooth, IrDA, and wireless LAN interfaces, and so on, to be connected to the mobile communication network 11.

FIG. 1 shows an example of mobile communication apparatus 10 that comprises two units of communication connection unit, i.e., the communication connection unit 12a and the communication connection unit 12b, in order to explain that at least two, or more units of communication connection unit are required.

The communication unit 13 connects to the mobile communication network 11 using the communication connection unit 12a or the communication connection unit 12b to perform data communication. Then, for example, the mobile communication apparatus 10 connects to the ISP via the mobile communication network 11, and further connects to the Internet via the ISP. This makes the use of the Internet service provided by the ISP for mobile communication apparatuses available.

When the communication unit 13 performs data communication using the communication connection unit 12a or 12b, the communication control unit 14 disables all communication unit except for the one that is being used for the data communication.

For example, when the communication unit 13 starts data communication using the communication unit 12a, the communication control unit 14 disables the communication connection unit 12b.

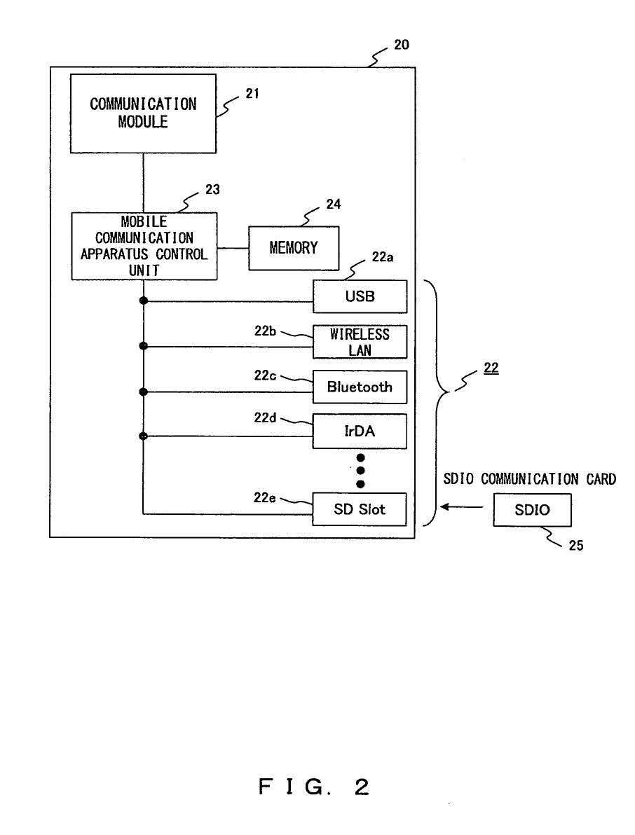

FIG. 2 is a diagram illustrating an example of a hardware configuration of a mobile communication apparatus 20 according to an embodiment of the present invention.

The mobile communication apparatus 20 shown in FIG. 2 comprises, at least, a communication module 21 for connecting to the mobile communication network 11 to perform data transmission/reception; an external interface 22 for connecting to an information processing apparatus, a network, etc. (not shown in the drawings) to perform data transmission/reception; a mobile communication apparatus control unit 23 for performing data communication using the communication module 21 and the external interface 22; and a memory 24 for storing a program and the like required for the operations of the mobile communication apparatus control unit 23.

In addition, the external interface 22 according to an embodiment of the present invention comprises a USB 22a, a wireless LAN 22b, a Bluethooth 22c, an IrDA 22d, and an SD Slot 22e with which an SDIO communication card 25 can be used.

In the configuration described above, the communication connection unit can be realized with the communication module 21 and the external interface 22. In this case, the communication module 21 may be configured as first communication connection unit, and one or more parts of the external interface 22 may be configured as second communication connection unit.

In addition, the communication unit and the communication control unit can be realized by executing the program stored in the memory 24, the execution made by the mobile communication apparatus control unit 23.

### First Embodiment

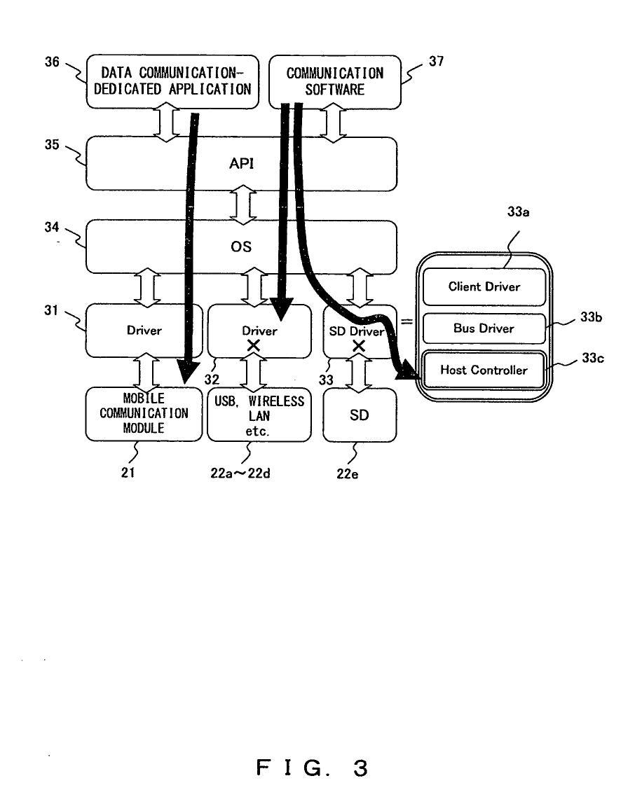

FIG. 3 is a schematic diagram showing functions of a mobile communication apparatus 20 according to a first embodiment of the present invention.

As shown in FIG. 3, the mobile communication apparatus 20 according to the present embodiment comprises, at least, the following elements: drivers 31-33 for directly controlling a communication module 21 and an external interface 22 to perform data transmission/reception; an OS (operating system) 34 for controlling the entirety of the mobile communication apparatus 20; an API (Application Program Interface) 35 of the OS 34; and a data communication-dedicated application 36 for performing data communication according to the present embodiment.

The SD driver 33 comprises a client driver 33a that is an interface between the SD driver 33 and the OS 34; a bus driver 33b for performing data control between an SDIO communication card 25, for example, inserted in an SD slot 22e and the OS 34; and a host controller 33c for controlling the SD slot 22e and the SDIO communication card 25 etc. inserted in the SD slot 22e.

For the mobile communication apparatus 20 according to the present embodiment, the data communication via the communication module 21 or the external interface 22 is available only by executing the data communication-dedicated application 36.

For example, in the case of performing the data communication using the communication module 21, when the user of the mobile communication apparatus 20 executes the data communication-dedicated application 36, the data communication-dedicated application 36 requests the OS 34, via the API 35, of a connection to the mobile communication network 11, and disables the driver 32 and the driver 33. Hereinafter, the disabled status is referred to as a “usage-prohibited mode” and an enabled status is referred to as a “usage-permitted mode.”

For example, execution-permission flags for controlling the execution of the drivers 31-33 are provided in the memory 24, and the execution-permission flag for the driver 31 is set to ON (execution-permitted) and the execution-permission flags for the driver 32 and the driver 33 are set to OFF (execution-prohibited).

The OS 34 operates the communication module 21 by calling the driver 31 in accordance with the instruction from the data communication-dedicated application 36, and connects to the mobile communication network 11, starting the data communication.

The drivers 31-33 refer to, when they are called by the OS 34, their own execution-permission flag stored in the memory 24. When the execution-permission flag is ON, the operation in accordance with the request from the OS 34 is started. When the execution-permission flag is OFF, the process is terminated immediately.

When, for example, communication software 37 having a router function is executed while the data communication is performed using the data communication-dedicated application 36, the communication software 37 calls the drivers 32 and 33 for controlling the external interface 22 (such as the wireless LAN 22b and the SDIO communication card 23), to connect to another information processing device, a network and so on. The drivers 32 and 33 refer to the execution-permission flags stored in the memory 24 and judge whether their execution is permitted or not.

While the data communication is performed using the data communication-dedicated application 36, the execution-permission flags of the driver 32 and 33 are set to OFF. In other words, drivers 32 and 33 are in the disabled status, and therefore terminate their operation without performing any instruction from the communication software 37.

Therefore, while the data communication-dedicated application 36 is engaged in the data communication, data communication with the outside world using the external interface 22 cannot be performed, making it possible to prevent a fraudulent access, via a mobile communication apparatus, to data communication service intended for mobile communication apparatuses, the access being made by, for example, equipping the mobile communication apparatus 20 with a router function.

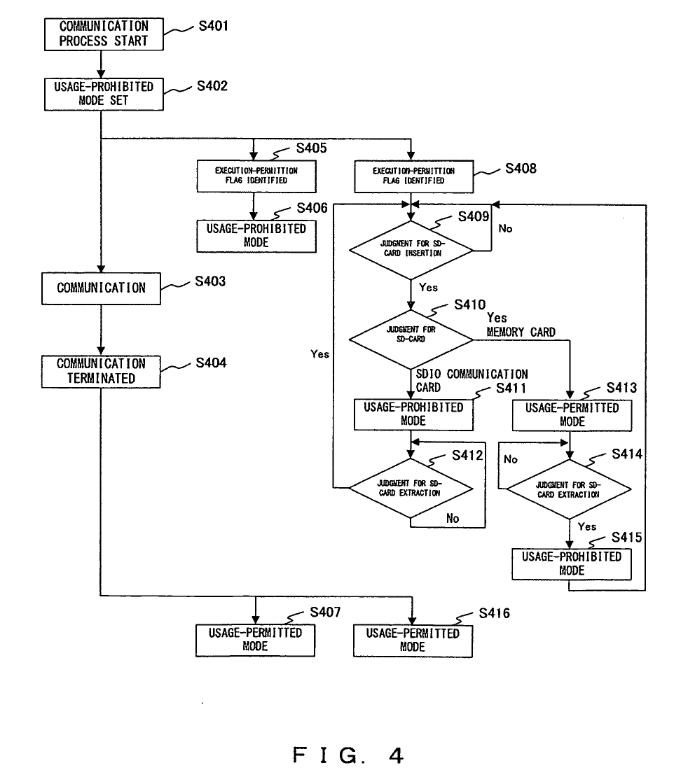

FIG. 4 is a flowchart showing processes performed by the mobile communication apparatus 20 according to the first embodiment of the present invention.

When the user of the mobile communication apparatus 20 executes the data communication-dedicated application 36, the data communication-dedicated application 36 calls the driver 31; control the communication module 21; and connects to the mobile communication network 11 (step S401).

The data communication-dedicated application 36 brings the process forward to step S402 when the connection to the mobile communication network 11 is completed.

In the step S402, the data communication-dedicated application 36 sets the execution-permission flags of the drivers 32 and 33 to OFF and requests the drivers 32 and 33 to change their modes.

When the setting of the usage-prohibited mode is completed, the data communication-dedicated application 36 brings the process forward to step S403, starting data communication.

When the data communication is terminated, the data communication-dedicated application 36 brings the process forward to step S404. Then the process is completed by setting the execution-permission flags of the drivers 32 and 33 that have been switched to the usage-prohibited mode to ON, and requesting the drivers 32 and 33 to change their modes, thereby setting their modes to the usage-permitted mode.

Meanwhile, when the request for the mode change is received from the data communication-dedicated application 36, the driver 32 for the parts of the external interface 22 except for the SD slot 22e refers to its execution-permission flag stored in the memory 24 (step S405).

In step S406, the driver 32 sets, for example, a mode flag used exclusively by the driver 32 to the usage-prohibited mode. In the present embodiment, the status with the mode flag ON is defined as the usage-prohibited mode, and the status with the mode flag OFF is defined as the usage-permitted mode.

During the usage-prohibited mode, the driver 32 terminates its operation without performing anything (or performs an abnormal termination), in response to any call from the communication software 37 and the like described in FIG. 3.

Meanwhile, when a mode change request to shift to the usage-permitted mode is received from the data communication-dedicated application 36, the driver 32 brings the process forward to step S407, changing its mode flag OFF to perform the mode change to the usage-permitted mode.

During the usage-permitted mode, the driver 32 operates the external interface 22 in accordance with instructions from the data communication-dedicated application 36, the communication software 37, etc., to perform data communication.

Meanwhile, when the mode change request is received from the data communication-dedicated application 36 in step S408, the driver 33 for the SD slot 22e refers to its execution-permission flag stored in the memory 24.

In step S409, the driver 33 checks whether or not an SD card is inserted in the SD slot 22e. When no SD card is inserted, the process is brought to step S409, and the process in the step S409 is repeated until an SD card is inserted. When an SD card is inserted, the process is brought forward to step S410.

In the step S410, the driver 33 obtains card-type information from the SD card interested in the SD slot 22e to determine whether or not the SD card is an SDIO communication card. When the SD card is an SDIO communication card, the driver 33 brings the process forward to step S411 and sets, for example, a mode flag used exclusively by the driver 33 to the usage-prohibited mode. In the same manner as for the driver 32, the status with the mode flag ON is defined as the usage-prohibited mode, and the status where with the mode flag OFF is defined as the usage-permitted mode.

When the mode change to the usage-prohibited mode is completed, the driver 33 brings the process forward to step S412 and monitors insertion/extraction of the SD card. In other words, the inserted status of the card is checked in the step S412, until the card is extracted. When the extraction of the card is detected, the process is brought to the step S409.

In the step S410, if an insertion of an SD card other than an SDIO communication card (for example, a memory card) in the SD Slot 22e is detected, the process is brought to step S413, setting the mode flag to the usage-permitted mode.

When the mode change to the usage-permitted mode is completed, the driver 33 brings the process forward to step S414 and monitors the insertion/extraction of the SD card. When the extraction of the SD card is detected in the step 414, the driver 33 brings the process forward to step S415, setting its mode flag to the usage-prohibited mode and then bringing the process to the step S409.

When a mode change request to shift to the usage-permitted mode is received from the data communication-dedicated application 36, the driver 33 brings the process forward to step S416, changing its mode flag OFF to perform the mode change to the usage-permitted mode.

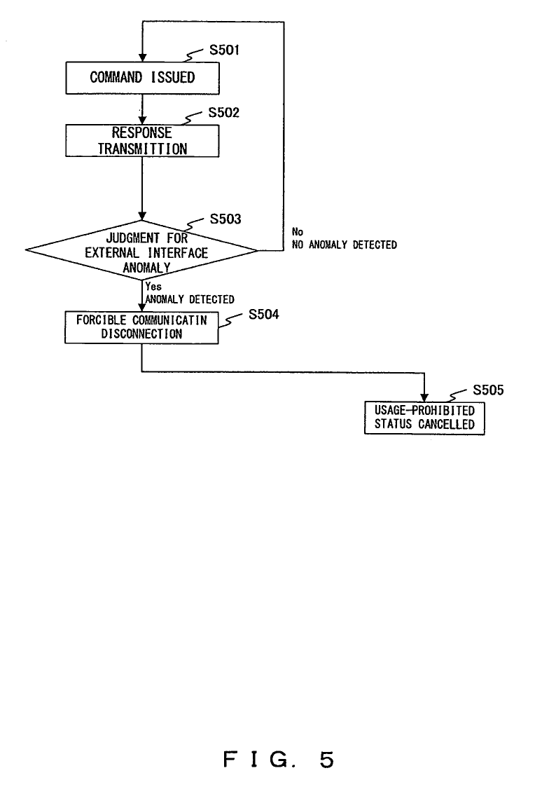

FIG. 5 is a flowchart showing a communication monitoring process performed by the mobile communication apparatus 20 according to the first embodiment of the present invention.

While the data communication-dedicated application 36 is engaged in the data communication, the monitoring process for monitoring a fraudulent use of the external interface 22 is performed regularly by executing the following processes.

In step S501, the data communication-dedicated application 36 issues a command to the drivers 32 and 33 (the drivers except for the one being used by the data communication-dedicated application 36 for the data communication) and requests information about their current mode.

When the command is received from the data communication-dedicated application 36, the drivers 32 and 33 refer their mode flags, and reply to the data communication-dedicated application 36 with the information about their current mode (the usage-prohibited mode or the usage-permitted mode).

In step S502, the data communication-dedicated application 36 receives the replies from the drivers 32 and 33.

In step S503, the data communication-dedicated application 36 checks whether there is any anomaly in the external interface 22 or not, i.e., whether or not the drivers 32 and 33 are used for a fraudulent communication.

While the data communication-dedicated application 36 is engaged in the data communication, the drivers (in this embodiment, the drivers 32 and 33) except for the one used for the data communication should be in the usage-prohibited mode. Therefore, the data communication-dedicated application 36 determines that there is an anomaly, when the drivers 32 and 33 are in the usage-permitted mode.

When there is an anomaly in the external interface 22 according to the judgment in the step S503, the data communication-dedicated application 36 brings the process forward to step S504.

In the step S504, the data communication-dedicated application 36 forcibly disconnects (forcibly terminates) the data communication that is currently being carried out, and terminates the process by setting the execution-permission flag to OFF and requesting the drives 32 and 33 to change their modes, thereby shifting the drivers 32 and 33 to the usage-permitted mode.

Meanwhile, when the request for the mode change to shift to the usage-permitted mode is received from the data communication-dedicated application 36, the drivers 32 and 33 bring the process forward to step S407, changing their mode flags ON to perform the mode change to the usage-permitted mode.

When there is no anomaly in the drivers 32 and 33 according to the judgment in the step S503, the data communication-dedicated application 36 brings the process to the step S501 and the process from the step S501 to S503 is repeated.

As described above, while the data communication-dedicated application 36 is engaged in data communication, the drivers except for the one being used for the data communication enter the usage-prohibited mode, making it possible to prevent another application (for example, the communication software 37 shown in FIG. 3) and the like from performing a fraudulent data communication with an information processing apparatus or a network connected to the mobile communication apparatus 20 via the external interface 22. For example, a fraudulent use of inexpensive data communication service intended for mobile communication apparatuses by a malicious user can be prevented, the fraudulent use being made from an information processing apparatus by installing a special application in a mobile communication apparatus 20 to make it function as a router and connecting its external interface such as a USB interface or wireless LAN interface to the information processing apparatus.

In addition, while the data communication-dedicated application 36 is engaged in data communication, the drivers except for the one used for the data communication are monitored, and when the mode of the drivers is fraudulently shifted (from the usage-prohibited mode to the usage-permitted mode), the data communication is forcibly disconnected (forcibly terminated). Therefore, even if, for example, the application installed to make the mobile communication apparatus 20 function as a router fraudulently attempts to use the driver for the external interface 22, the data communication is forcibly disconnected, preventing a fraudulent use of inexpensive data communication service intended for mobile communication apparatuses, from an information processing apparatus connected to the mobile communication apparatus.

As a result, the provider of the data communication service intended for mobile communication apparatuses can provide the data communication service intended for mobile communication apparatuses only for the users of the mobile communication apparatuses, which also enables the providers to apply inexpensive charging systems to mobile communication apparatuses and helps to increase their user bases.

### Second Embodiment

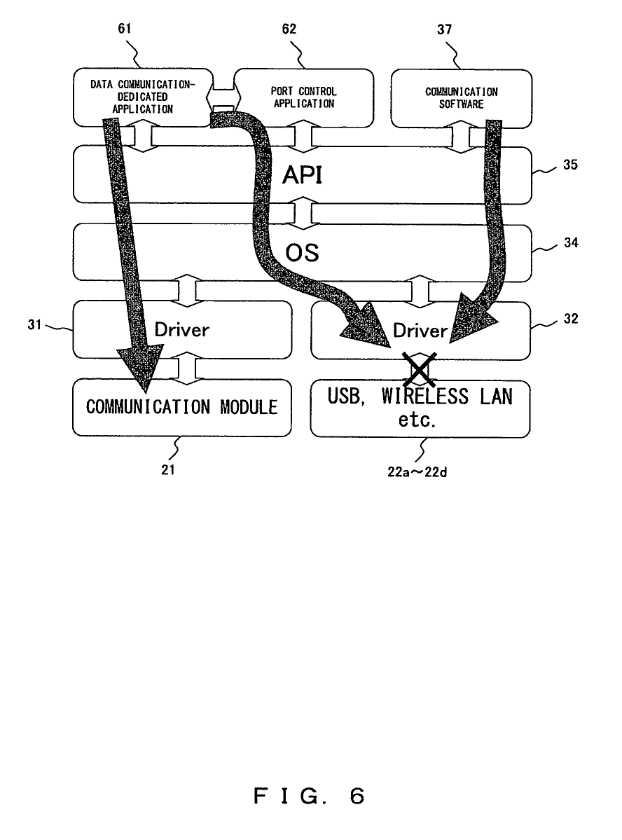

FIG. 6 is a schematic diagram showing functions of a mobile communication apparatus 20 according to a second embodiment of the present invention.

The mobile communication apparatus 20 according the present embodiment shown in FIG. 6 comprises, at least, the following elements: drivers 31 and 32 for directly controlling the communication module 21 and the external interface 22 to perform data transmission/reception; an OS 34 for controlling the entirety of the mobile communication apparatus 20; an API 35 of the OS 34; a data communication-dedicated application (communication unit) 61 for performing data communication according to the present embodiment; as well as a port control application (communication control unit) 62 for dedicatedly performing control of ports.

The SD driver 33 shown in FIG. 3 is omitted from FIG. 6, not to exclude it intentionally but purely to make the explanation simple.

The above-mentioned “port” according to the present invention refers to identification information of assigned to devices and interfaces when they connect to the mobile communication apparatus 20 for communication.

The example includes identification information of (1) devices such as a PC card and an SD card to be connected to the external interface 22, and (2) interfaces such as serial/parallel, USB, IEEE (Institute of Electrical and Electronic Engineers) 1394, IrDA (Infrared Data Association) interfaces.

Each port is registered in, for example, a port control table stored in the memory 24, to perform controls, such as to implement/not to implement the port. The OS 34 refers to the port control table and loads, on the memory, a driver for performing communication with a device corresponding to the port.

In the mobile communication apparatus 20 according to the present embodiment, the data communication via the communication module 21 or the external interface 22 is available only by executing the data communication-dedicated application 61.

For example, in the case of performing the data communication using the communication module 21, when the user of the mobile communication apparatus 20 executes the data communication-dedicated application 61, the data communication-dedicated application 61 requests the OS 34, via the API 35, of a connection to the mobile communication network 11, and issues an instruction to the port control application 62 to prohibit the usage of ports except for the one for the communication module 21.

When the instruction is received, the port control application 62 sets the ports registered in the port control table to a not-implemented status, so as to disable the driver 32 by releasing it from the memory. Hereinafter, the disabled status is referred to as a “usage-prohibited mode” and an enabled status is referred to as a “usage-permitted mode.”

For example, when the port control application 62 sets the ports registered in the port control table except for the one for the communication module 21 to the not-implemented status, the OS 34 refers to the port control table; determines that the ports except for the one for the communication module 21 are in the usage-prohibited status; and releases the driver (in FIG. 6, the driver 32) for the ports except for the one for the communication module 21 from the memory.

Thus, while the data communication-dedicated application 61 is engaged in data communication, data communication with the outside world using the external interface 22 cannot be performed, making it possible to prevent a fraudulent access, via a mobile communication apparatus, to data communication service intended for mobile communication apparatuses, the access being made by, for example, equipping the mobile communication apparatus 20 with a router function.

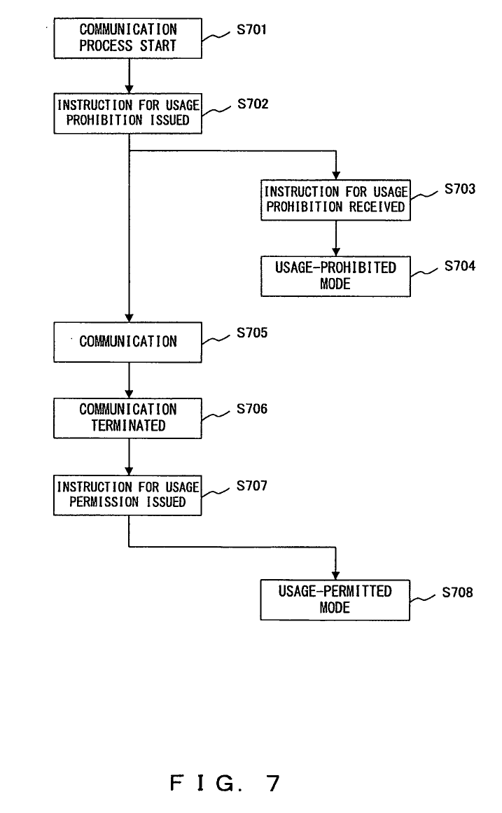

FIG. 7 is a flowchart showing processes performed by the mobile communication apparatus 20 according to the second embodiment of the present invention

When the user of the mobile communication apparatus 20 executes the data communication-dedicated application 61, the data communication-dedicated application 61 calls the driver 31; control the communication module 21; and connects to the mobile communication network 11 (step S701).

When the connection to the mobile communication network 11 is completed, the data communication-dedicated application 61 brings the process forward to step S702.

In the step S702, the data communication-dedicated application 61 transmits, to the port control application 62, an instruction to prohibit the usage of the ports except for the one for the communication module 21.

Meanwhile, when the usage-prohibit instruction is received from the data communication-dedicated application 61 in step S703, the port control application 62 brings the process forward to step S704, and refers to, for example, the port control table stored in the memory 24 and the like, to set the port except for the one for the communication module 21 to the not-implemented status (to the usage-prohibited mode).

When the not-implemented status is set in the port control table by the port control application 62, the OS 34 disables the driver (for example, the driver 32 shown in FIG. 6) for operating the ports that have been set to the not-implemented states, by releasing the driver from the memory.

During the usage-prohibited mode, even if the software 37 described in FIG. 3 and the like calls the driver 32 in an attempt of a fraudulent communication, it fails, as the driver 32 is not loaded on the memory.

When the setting of the usage-prohibited mode is completed in the step S702, the data communication-dedicated application 61 brings the process forward to step S705 and starts data communication.

When the data communication is terminated, the data communication-dedicated application 61 brings the process forward to step S706; terminates the communication by performing processes such as to cancel the connection with the mobile communication network 11; and brings the process forward to step S707.

In step S707, the data communication-dedicated application 61 transits, to the port control application 62, an instruction to permit the usage of the ports of which usage was prohibited by the instruction issued in step S702.

Meanwhile, when the usage-permission instruction is received from the data communication-dedicated application 61 in step S708, the port control application 62 refers to the port control table, and switches the ports that were set to the non-implemented status in step S704 to the implemented status (to the usage-permitted mode), and terminates the process.

When the implemented status is set in the port control table by the port control application 62, the OS 34 enables the driver 32 for operating the ports that have been to the implemented status, by loading the driver on the memory.

The process from the step S702 to the S704 may also be performed as follows. For example, when the data communication-dedicated application 61 issues a usage-prohibit instruction to the port control application 62, a permission flag may be provided in the memory 24, and the data communication-dedicated application 61 may set the permission flag to OFF (usage-prohibited mode), so that, when the flag set to OFF is detected, the port control application 62 sets the ports in the port control table except for the one for the communication module 21 to the not-implemented status.

In the same manner, the process from the step S707 to the step S708 may also be performed as follows. For example, the data communication-dedicated application 61 may set the above-described permission flag to ON (usage-permitted mode), so that, the port control application 62 monitoring the permission flag detects the permission flag set to ON, the ports that were set to the not-implemented stats in the step S704 are switched to the implemented status.

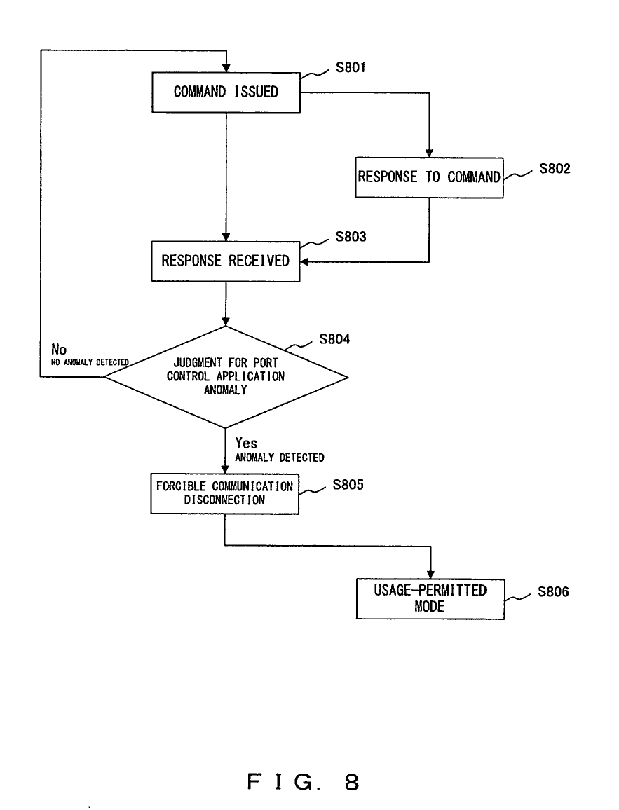

FIG. 8 is a flowchart showing a communication monitoring processes performed by the mobile communication apparatus 20 according to the second embodiment of the present invention.

While the data communication-dedicated application 61 is engaged in the data communication, the monitoring process for monitoring a fraudulent use of the external interface 22 is performed regularly by executing the following processes.

In step S801, the data communication-dedicated application 61 issues a command to the port control application 62 and requests information about its current mode.

When the command is received from the data communication-dedicated application 61 in step S802, the port control application 62 replies to the data communication-dedicated application 61 with the information about the current mode (the usage-prohibited mode or the usage-permitted mode).

In this case, the mode information may be maintained by providing a mode flag in the memory 24 and setting it to ON to for the usage-prohibited mode and setting it to OFF for the usage-permitted mode. In addition, the status where only the communication module 21 is implemented may be determined as the usage-prohibited mode, by referring to the port control table.

In the step S803, the data communication-dedicated application 61 receives the reply from the port control application.

In step S804, the data communication-dedicated application 61 checks whether there is any anomaly in the port control application 62 or not, i.e., whether or not the driver 32 is used for a fraudulent communication.

For example, while the data communication-dedicated application 61 is engaged in the data communication, the port control application 62 should be in the usage-prohibited mode. Therefore, the data communication-dedicated application 61 determines that there is an anomaly, when the received mode information indicates the usage-permitted mode.

When there is an anomaly in the port control application 62 according to the judgment in the step S804, the data communication-dedicated application 61 brings the process forward to step S805.

In the step S805, the data communication-dedicated application 61 forcibly disconnects (forcibly terminates) the data communication that is currently being carried out, and transmits a usage-permission command to the port control application 62.

Meanwhile, when the usage-permission instruction is received from the data communication-dedicated application 61 in step S806, the port control application 62 refers to the port control table, and switches the ports that were set to the non-implemented status in step S704 to the implemented status (to the usage-permitted mode), and terminates the process.

When the implemented status is set in the port control table by the port control application 62, the OS 34 enables the driver 32 for operating the ports that have been set to the implemented status, by loading the driver on the memory.

Meanwhile, when there is no anomaly in the port control application according to the judgment in the step S804, the data communication-dedicated application 61 brings the process to the step S801 and the process from the step S801 to S804 is repeated.

As described above, the present embodiment has the same effect as that of the first embodiment.

In other words, while the data communication-dedicated application 61 is engaged in data communication, the usage-prohibited mode is set and the drivers except for the driver 31 for operating the communication module 21 to be used for the data communication by the data communication-dedicated application 61 enter the status where they are not loaded on the memory. This makes it possible to prevent another application (for example, the communication software 37 shown in FIG. 3) and the like from performing a fraudulent data communication with an information processing apparatus or a network connected to the mobile communication apparatus 20 via the external interface 22.

For example, a fraudulent use of inexpensive data communication service intended for mobile communication apparatuses by a malicious user can be prevented, the fraudulent use being made from an information processing apparatus by installing a special application in a mobile communication apparatus 20 to make it function as a router and connecting its external interface such as a USB interface or wireless LAN interface to the information processing apparatus.

In addition, while the data communication-dedicated application 61 is engaged in data communication, the drivers except for the one being used for the data communication are monitored, and when the drivers are fraudulently loaded on the memory (when their mode is shifted from the usage-prohibited mode to the usage-permitted mode), the data communication is forcibly disconnected (forcibly terminated). Therefore, even if, for example, the application installed to make the mobile communication apparatus 20 function as a router fraudulently attempts to use the driver for the external interface 22, the data communication is forcibly disconnected, preventing a fraudulent use of inexpensive data communication service intended for mobile communication apparatuses, from an information processing apparatus connected to the mobile communication apparatus.

As a result, the provider of the data communication service intended for mobile communication apparatuses can provide the data communication service intended for mobile communication apparatuses only for the users of the mobile communication apparatuses, which also enables the providers to apply inexpensive charging systems to mobile communication apparatuses and helps to increase their user bases.

### Third Embodiment

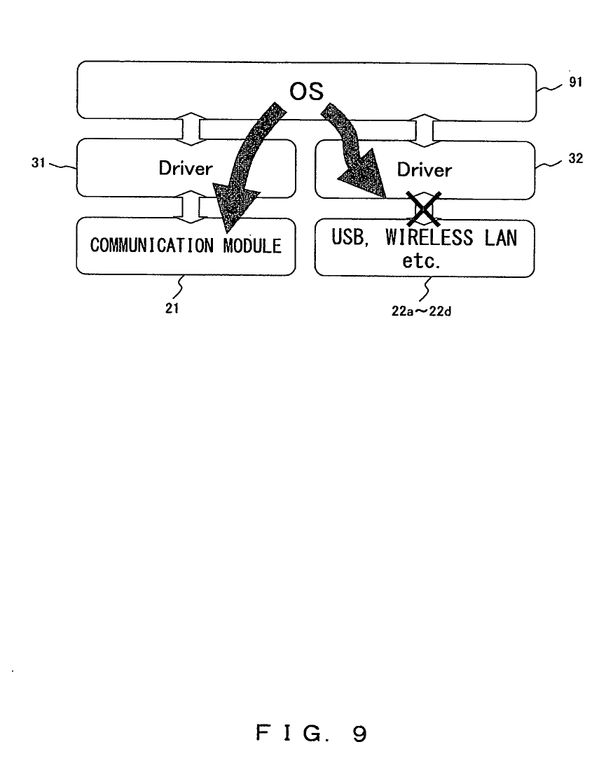

FIG. 9 is a schematic diagram showing functions of a mobile communication apparatus 20 according to a third embodiment of the present invention.

The mobile communication apparatus 20 according the present embodiment shown in FIG. 9 comprises, at least, the following elements: drivers 31 and 32 for directly controlling the communication module 21 and the external interface 22 to perform data transmission/reception; an OS (basic operation control unit) 91 for controlling the entirety of the mobile communication apparatus 20 and for performing data communication according to the present embodiment.

The SD driver 33 shown in FIG. 3 is omitted from FIG. 9, in the same manner as in FIG. 6 described with the second embodiment, not to exclude it intentionally but purely to make the explanation simple.

In the mobile communication apparatus 20 according to the present embodiment, the data communication via the communication module 21 or the external interface 22 is available only with the communication function of the OS 91.

For example, in the case of performing the data communication using the communication module 21, when the user of the mobile communication apparatus 20 instructs, through a Web browser, e-mail, or by tapping a button dedicated to communication, the OS 91 to start communication, the OS 91 requests, via the communication module 21, of a connection to the mobile communication network 11; sets the ports registered in the port control table except for the one for the communication module 21 to the not-implemented status; and disables the driver 32 by releasing it from the memory. Hereinafter, the disabled status is referred to as a “usage-prohibited mode” and an enabled status is referred to as a “usage-permitted mode.”

For example, when it starts the communication, the OS 91 sets the ports registered in the port control table except for the one for the communication module 21 to the not-implemented status; releases the driver 32 for the ports except for the one for the communication module 21 from the memory; operates the communication module 21 by calling the driver 31; connects to the mobile network 11; and starts the data communication.

Thus, while the OS 91 is engaged in data communication, data communication with the outside world using the external interface 22 cannot be performed, making it possible to prevent a fraudulent access, via a mobile communication apparatus, to data communication service intended for mobile communication apparatuses, the access being made by, for example, equipping the mobile communication apparatus with a router function.

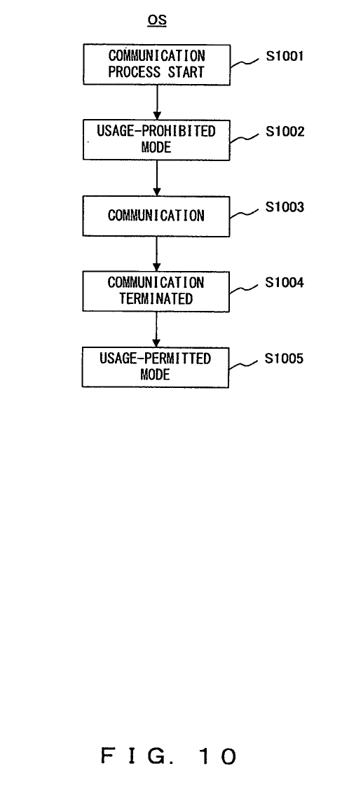

FIG. 10 is a flowchart showing processes performed by the mobile communication apparatus 20 according to the third embodiment of the present invention.

When the user of the mobile communication apparatus 20 instructs the OS 91 to start the communication, the OS 91 operates the communication module 21 by calling the driver 31, and connects to the mobile communication network 11 (step S1001).

When the connection to the mobile communication network 11 is completed, the OS 91 brings the process forward to step S1002 and refers to, for example, the port control table stored in the memory 24 and the like, to set the ports except for the one for the communication module 21 to the not-implemented status (to the usage-prohibited mode). Then the driver (for example, the driver 32 shown in FIG. 9) for operating the ports that have been set to the not-implemented status is released from the memory and disabled (switched to the usage-prohibited mode).

During the usage-prohibited mode, even if the software 37 described in FIG. 3 and the like calls the driver 32 in an attempt of a fraudulent communication, it fails, as the driver 32 is not loaded on the memory.

For the OS 91 according to the present embodiment, the process in step S1002 may be performed regularly to perform a reset to the usage-prohibited mode, until the mode is switched to the usage-permitted mode.

When the setting of the usage-prohibited mode is completed in the step S1002, the OS 91 brings the process to forward to step S1003 and starts data communication.

When the data communication is terminated, the OS 91 brings the process forward to step S1004; terminates the communication by performing processes such as to cancel the connection with the mobile communication network 11; and brings the process forward to step S1005.

In the step S1005, the OS 91 refers to the port control table, and switches the ports that were set to the non-implemented status in step S1002 to the implemented status (to the usage-permitted mode), and enables (switches to the usage-permitted mode) the driver 32 for operating the ports that have been to the implemented status, by loading the driver on the memory.

As described above, the present embodiment has the same effect as that of the first embodiment.

In other words, while the OS 91 is engaged in data communication, the usage-prohibited mode is set and the drivers except for the driver 31 for operating the communication module 21 to be used for the data communication by the OS 91 enter the status where they are not loaded on the memory. This makes it possible to prevent another application (for example, the communication software 37 shown in FIG. 3) and the like from performing a fraudulent data communication with an information processing apparatus or a network connected to the mobile communication apparatus 20 via the external interface 22.

For example, a fraudulent use of inexpensive data communication service intended for mobile communication apparatuses by a malicious user can be prevented, the fraudulent use being made from an information processing apparatus by installing a special application in a mobile communication apparatus 20 to make it function as a router and connecting its external interface such as a USB interface or wireless LAN interface to the information processing apparatus.

In addition, while the OS 91 is engaged in data communication, a reset to the usage-prohibited mode is performed regularly. Therefore, even if, for example, the application installed to make the mobile communication apparatus 20 function as a router fraudulently attempts to use the driver for the external interface 22, the driver is released from the memory, preventing a fraudulent use of inexpensive data communication service intended for mobile communication apparatuses, from an information processing apparatus connected to the mobile communication apparatus.

As a result, the provider of the data communication service intended for mobile communication apparatuses can provide the data communication service intended for mobile communication apparatuses only for the users of the mobile communication apparatuses, which also enables the providers to apply inexpensive charging systems to mobile communication apparatuses and helps to increase their user bases.

What is claimed is:

1. A mobile communication apparatus that can be connected to a mobile communication network, comprising:
communication connection unit for enabling data transmission/reception by connecting, electromagnetically or electrically, the mobile communication apparatus and the mobile communication network, another information processing apparatus or a network;
communication unit for performing data communication by connecting to the mobile communication network using the communication connection unit; and
communication control unit for disabling, during the data communication, communication of data that uses any communication connection unit except for the communication connection unit being used for the data communication.

2. The mobile communication apparatus according to claim 1, wherein
the communication connection unit comprises;
first communication connection unit for enabling data transmission/reception by connecting to a network via the mobile communication network; and
one or more units of second communication connection unit for enabling data transmission/reception by connecting to another information processing apparatus directly or via a network,
and,
upon detecting data communication using the first communication connection unit, the communication control unit disables the second communication connection unit to prohibit data communication using the second communication connection unit.

3. The mobile communication apparatus according to claim 2, further comprising:
communication monitoring unit for monitoring a status of the second communication connection unit while data communication is performed using the first communication connection unit, and upon detecting the second communication connection unit being in an enabled status, disabling the second communication connection unit again.

4. A method for preventing a fraudulent use of a mobile communication network by a mobile communication apparatus, the method making the mobile communication apparatus perform processes comprising:
monitoring data communication using a communication connection unit for enabling data transmission/reception by connecting, electromagnetically or electrically, the mobile communication apparatus and the mobile communication network, another information processing apparatus or a network; and
disabling, during the data communication, communication of data that uses any communication connection unit except for the communication connection unit being used for the data communication.

5. The method for preventing a fraudulent use of a mobile communication network according to claim 4, the method making the mobile communication apparatus perform a process of:
upon detecting data communication using a first communication connection unit for enabling data transmission/reception by connecting to a network via the mobile communication network, disabling one or more units of a second communication connection unit for enabling data transmission/reception by connecting to another information processing apparatus directly or via a network, to prohibit data communication using the second communication connection unit.

6. The method for preventing a fraudulent use of a mobile communication network according to claim 4, the method making the mobile communication apparatus perform processes of:
monitoring a status of the second communication connection unit while data communication is performed using the first communication connection unit; and
upon detecting the second communication connection unit being in an enabled status, disabling the second communication connection unit again.

7. A recording medium for program to prevent a fraudulent use of a mobile communication network by a mobile communication apparatus, the program making the mobile communication apparatus perform processes comprising:
monitoring data communication using a communication connection unit for enabling data transmission/reception by connecting, electromagnetically or electrically, the mobile communication apparatus and the mobile communication network, another information processing apparatus or a network; and
disabling, upon detecting the data communication, communication of data that uses any communication connection unit except for the communication connection unit being used for the data communication.

8. The recording medium for program to prevent a fraudulent use of a mobile communication network according to claim 7, the program making the mobile communication apparatus perform a process of:
upon detecting data communication using a first communication connection unit for enabling data transmission/reception by connecting to a network via the mobile communication network, disabling one or more units of a second communication connection unit for enabling data transmission/reception by connecting to another information processing apparatus directly or via a network, to prohibit data communication using the second communication connection unit.

9. The recording medium for program to prevent a fraudulent use of a mobile communication network according to claim 7, the program making the mobile communication apparatus perform processes of:
monitoring a status of the second communication connection unit while data communication is performed using the first communication connection unit; and
upon detecting the second communication connection unit being in an enabled status, disabling the second communication connection unit again.

10. A mobile communication apparatus that can be connected to a communication network, comprising:
communication connection unit for enabling data transmission/reception by connecting, electromagnetically or electrically, the mobile communication apparatus and the communication network, another information processing apparatus or a network;
communication unit for performing data communication by connecting to the communication network using the communication connection unit; and
communication control unit for disabling, during the data communication, communication of data that uses any communication connection unit except for the communication connection unit being used for the data communication.

11. A method for preventing a fraudulent use of a communication network by a mobile communication apparatus, the method making the mobile communication apparatus perform processes comprising:
monitoring data communication using a communication connection unit for enabling data transmission/reception by connecting, electromagnetically or electrically, the mobile communication apparatus and the communication network, another information processing apparatus or a network; and
disabling, during the data communication, communication of data that uses any communication connection unit except for the communication connection unit being used for the data communication.

12. A recording medium for program to prevent a fraudulent use of a communication network by a mobile communication apparatus, the program making the mobile communication apparatus perform processes comprising:
monitoring data communication using a communication connection unit for enabling data transmission/reception by connecting, electromagnetically or electrically, the mobile communication apparatus and the communication network, another information processing apparatus or a network; and
upon detecting the data communication, disabling communication of data that uses any communication connection unit except for the communication connection unit used for the detected data communication.

13. A mobile communication apparatus that can be connected to a mobile communication network, comprising:
communication connection unit for enabling data transmission/reception by connecting, electromagnetically or electrically, the mobile communication apparatus and the mobile communication network, another information processing apparatus or a network;
communication unit for performing data communication by connecting to the mobile communication network using the communication connection unit and for issuing an instruction to disable communication of data that uses any communication connection unit except for the communication connection unit being used for the data communication; and
communication control unit for disabling, in accordance with the instruction, communication of data that uses any communication connection unit except for the communication connection unit being used for the data communication.

14. The mobile communication apparatus according to claim 13, wherein
the communication connection unit comprises;
first communication connection unit for enabling data transmission/reception by connecting to a network via the mobile communication network; and
one or more units of second communication connection unit for enabling data transmission/reception by connecting to another information processing apparatus directly or via a network,
and,
upon detecting data communication using the first communication connection unit, the data communication unit disables the second communication connection unit to prohibit data communication using the second communication connection unit.

15. The mobile communication apparatus according to claim 14, wherein
the communication unit monitors a status of the second communication connection unit while data communication is performed using the first communication connection unit, and upon detecting the second communication connection unit being in an enabled status, disables the second communication connection unit again.

16. A mobile communication apparatus that can be connected to a mobile communication network, comprising:
communication connection unit for enabling data transmission/reception by connecting, electromagnetically or electrically, the mobile communication apparatus and the mobile communication network, another information processing apparatus or a network;
basic operation control unit that realizes basic operations of the mobile communication apparatus including data communication using the communication connection unit, while performing data communication by connecting to the mobile communication network using the communication connection unit, and disabling, during the data communication, communication of data that uses any communication connection unit except for the communication connection unit being used for the data communication.

17. The mobile communication apparatus according to claim 16, wherein
the communication connection unit comprises;
first communication connection unit for enabling data transmission/reception by connecting to a network via the mobile communication network; and
one or more units of second communication connection unit for enabling data transmission/reception by connecting to another information processing apparatus directly or via a network,
and,
upon a start of data communication using the first communication connection unit, the basic operation control unit disables the second communication connection unit to prohibit data communication using the second communication connection unit.
